(19) United States
(12) Patent Application Publication
(10) Pub. No.: US 2015/0149144 A1
(43) Pub. Date: May 28, 2015

(54) SIMULATING NON-VOLATILE MEMORY

(71) Applicant: Lenovo (Singapore) Pte. Ltd., Singapore (SG)

(72) Inventor: Mark Charles Davis, Durham, NC (US)

(73) Assignee: Lenovo (Singapore) Pte. Ltd., Singapore (SG)

(21) Appl. No.: 14/089,845

(22) Filed: Nov. 26, 2013

(51) Int. Cl. G06F 17/50

(52) U.S. Cl. CPC G06F 17/5009
USPC 703/20

(57) ABSTRACT

An embodiment provides a method, including: detecting, using a processor, a volatile memory device of an information handling device; and designating, using a processor, at least a portion of the volatile memory device as simulated non-volatile memory. Other aspects are described and claimed.

### BACKGROUND

Information handling devices (“devices”) come in a variety of forms. Such devices share some common traits, for example execution of instructions using a processor, with the instructions or code stored in a memory device. Different devices utilize different types of memory devices depending on the capabilities of the device, the availability of memory devices (e.g., cost, technological development, etc.). Memory devices therefore are an important device component.

Different memory devices operate in different ways. For example, conventionally the construction of “main memory” or “system memory”, e.g., as found in laptop and desktop computing devices, dictates that these memory devices retain information (e.g., stored instructions, files, data, etc.) only so long as the memory device is powered or energized, i.e., it is volatile. It is generally accepted that the use of main memory or system memory, even though volatile, provides performance improvements for the devices, e.g., quicker response when attempting to load instructions, retrieve files or data, etc. In contrast, other memory devices, e.g., hard disk drives (HDD), flash memory, etc., are non-volatile and thus retain information when not powered or energized.

As a result, operating systems (OS) have been designed to rely on data and programs stored in a backing store such as HDDs or flash memory, copying frequently used information into a volatile memory during use for quick access. Non-volatile memory technologies, e.g., non-volatile random access memory (NVRAM), have been refined to include newer forms, e.g., magneto-resistive random access memory (MRAM), spin transfer torque random access memory (STT-RAM), and resistive random access memory (ReRAM or RRAM). These newer non-volatile memory devices provide persistent or non-volatile memory at price-performance points accommodating replacement of existing main memory (i.e., volatile memory) technologies with these newer non-volatile memory devices.

### BRIEF SUMMARY

In summary, one aspect provides a method, comprising: detecting, using a processor, a volatile memory device of an information handling device; and designating, using a processor, at least a portion of the volatile memory device as simulated non-volatile memory.

Another aspect provides an information handling device, comprising: a volatile memory device; a processor; and a memory device storing instructions executable by the processor to: detect the volatile memory device of an information handling device; and designate at least a portion of the volatile memory device as simulated non-volatile memory.

A further aspect provides a program product, comprising: a storage medium comprising computer readable program code, the computer readable program code comprising: computer readable program code configured to detect, using a processor, a volatile memory device of an information handling device; and computer readable program code configured to designate, using a processor, at least a portion of the volatile memory device as simulated non-volatile memory.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example of designating a portion of volatile memory as simulated non-volatile memory.

FIG. 4 illustrates an example of copying contents of simulated non-volatile memory to a backing store.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While newer forms of non-volatile memory, e.g., magneto-resistive random access memory (MRAM), spin transfer torque random access memory (STT-RAM), and resistive random access memory (ReRAM or RRAM), are becoming available at price-performance points accommodating replacement of existing (and heretofore more economical) main memory (i.e., volatile memory) technologies, these new non-volatile memory devices will not yield full benefits as long as the operating system (OS) does redundant copying. That is, currently operating systems are not configured to take advantage of a hardware platform where volatile memory has been replaced with non-volatile memory. On the other hand, an OS that takes advantage of non-volatile memory devices (i.e., in lieu of or in addition to volatile or conventional main memory) cannot be developed or run on existing hardware platforms that lack these new memory devices. Thus, current approach is to not exploit non-volatile memory devices with the current OS designs, thus giving sub-optimal performance.

An embodiment therefore provides a way to make conventional volatile memory (e.g., “main memory”) appear to a redesigned operating system as if it were non-volatile memory. This allows development of redesigned (i.e., non-volatile memory exploiting) operating systems and also allows for flexibly accommodating operating multiple system designs, e.g., permitting an OS to run efficiently on either type of hardware platform.

The illustrated example embodiments will be best understood by reference to the figures. The following description is intended only by way of example, and simply illustrates certain example embodiments.

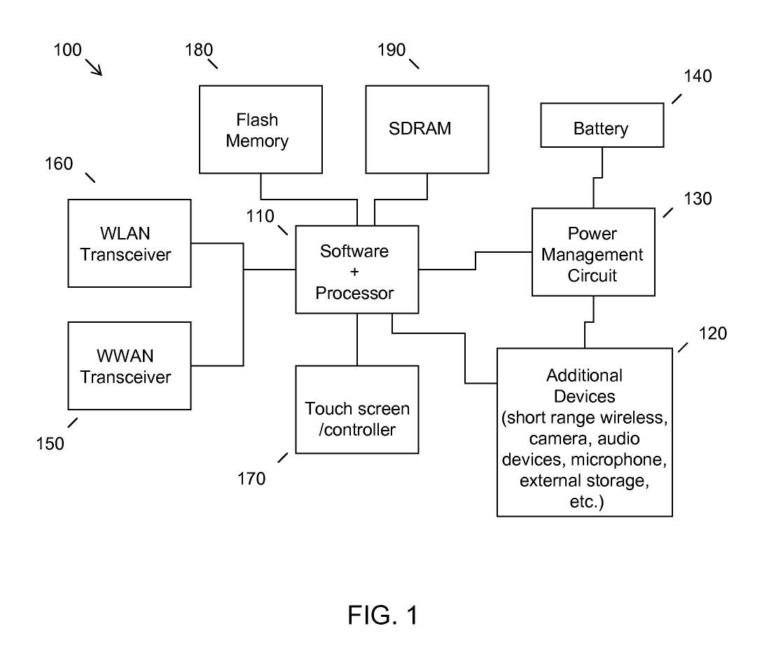

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio, or element(s) that may be used for near field communications. Commonly, system 100 will include a touch screen 170 for data input and display. System 100 also typically includes various memory devices, for example flash memory 180 and SDRAM 190.

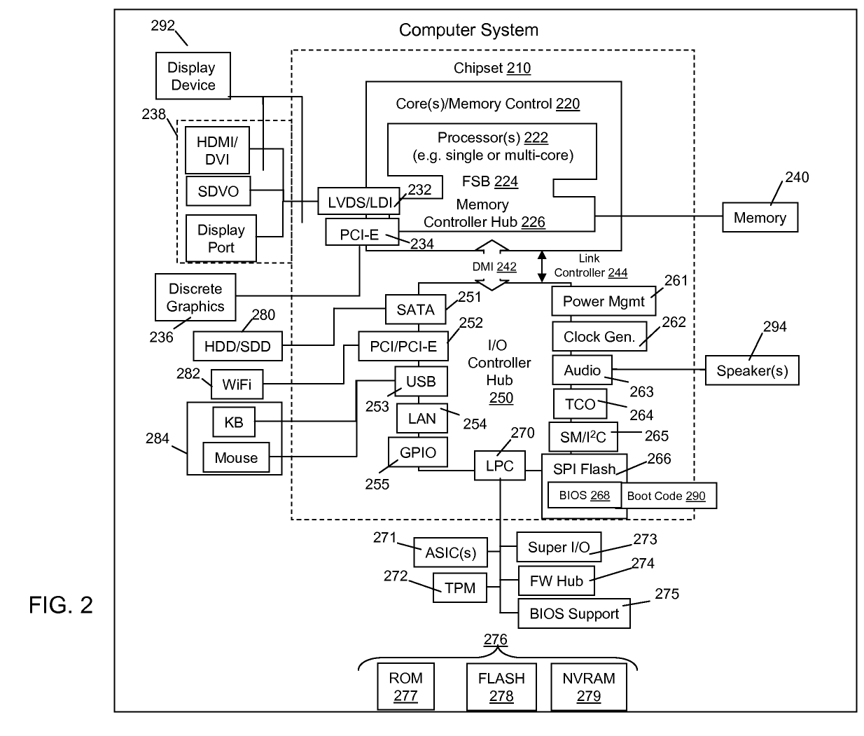

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be utilized in various devices according to the embodiments described herein. For example, the circuitry outlined in FIG. 1 or FIG. 2 may include both volatile and non-volatile memory that is utilized by an operating system, as described herein. For example, the circuitry outlined in FIG. 1 and FIG. 2, in a conventional operation, initiates or starts a system by loading persistently stored data (e.g., instructions, programs, other data) from a non-volatile memory store, e.g., HDD, to a main memory (volatile memory), which is more quickly accessed during device operation.

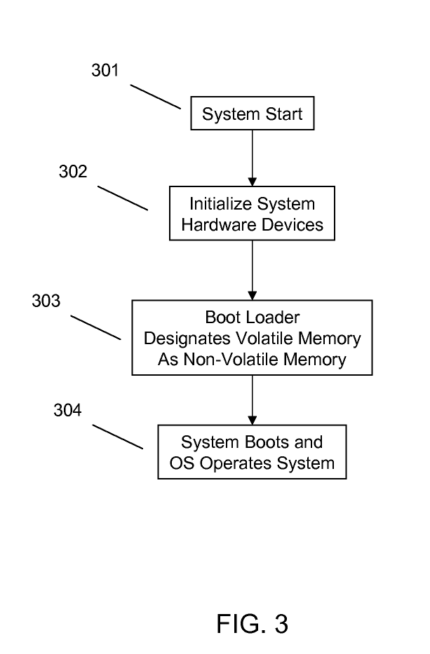

An embodiment makes conventional volatile memory (e.g., “main memory”) appear to the operating system as if it were non-volatile memory. Referring to FIG. 3 by way of example, when a device initializes or starts up (or is reset) at 301, the device begins executing some very low level code that initializes all of the parts of the system, including initializing hardware at 302. This code is frequently referred to as BIOS or POST.

Once hardware (e.g., various memory devices) is initialized at 302, a program, e.g., “boot loader” or “boot strap loader” is run to boot the device at 303. This loader program is often part of the BIOS/POST code and may take advantage of all the hardware that has been initialized. The loader program reads information from to backing store (e.g., HDD, flash memory, etc.) into a main memory (volatile memory) and transfers control to the loaded information to the operating system so the machine will “boot” at 304.

To simulate non-volatile memory, e.g., NVRAM, in an embodiment the loader program (e.g., boot loader or other equivalent program, depending on the device) is modified to accomplish several additional tasks. As illustrated in FIG. 3, the loader program is modified to take some or all of the identified main memory available and designate or reserve it for non-volatile memory (e.g., NVRAM) use at 303. This program may clear this designated memory later, and/or copy stored data from backing store (e.g., HDD, flash, etc.) into the volatile memory, e.g., according to predetermined timing policies. The program may also initialize any control structures in the main memory to permit verification of contents. Once the volatile memory has been designated as non-volatile memory, the simulated non-volatile memory may be utilized by the OS when the system boots at 304.

When a device starts for the first time at 301, no previous data will be available in the volatile memory, as it cannot persistently store the data if not powered or energized. Thus, the simulated non-volatile memory will be empty. The initialization of control structures will show that the non-volatile memory is indeed empty. Accordingly, information may be copied to/stored in the non-volatile memory at various times, e.g., as a task during operation of the system, prior to booting the system (e.g., to fetch a set of data utilized early in an OS operation following boot up), etc.

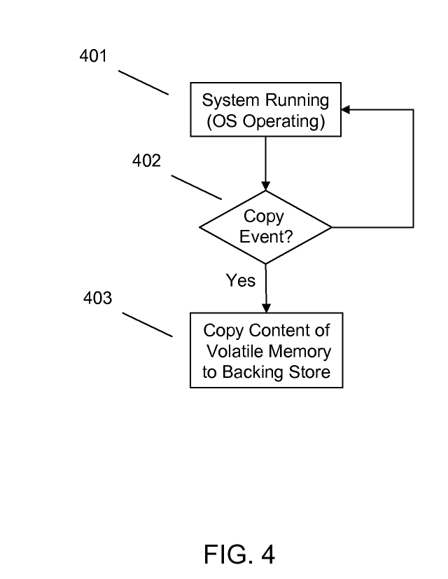

During operation, referring to FIG. 4, when the simulated non-volatile memory has information stored therein, an embodiment may provide an application to check the state of the simulated non-volatile memory and write the contents to a persistent backing store (e.g., HDD, flash, etc.). Thus, during operation of the system at 401, a trigger or copy event may be detected at 402. For example, a system shutdown may be detected, a predetermined time may have elapsed, a predetermined amount of simulated non-volatile memory may have been utilized, etc. If a copy event is detected at 402, an embodiment may copy back to persistent or backing store some or all of the contents of the simulated non-volatile memory at 403.

The check and copy back operation thus may be provided at various times, e.g., periodically, frequently, according to a schedule, etc. For example, this same application may be called at shutdown to get the most up-to-date information stored in the simulated non-volatile memory recorded to a backing store prior to shutdown and loss of volatile memory storage capability. Additionally, to protect against power loss or other catastrophic failure (i.e., situations where the volatile memory simulating non-volatile memory is without power), a periodic or frequent or scheduled backup should also be done to mitigate the risk of loosing important data from the simulated non-volatile memory store in such circumstances.

An embodiment therefore allows conventional volatile memory (e.g., “main memory”) to simulate non-volatile memory, e.g., from the perspective of the operating system. This allows development of non-volatile memory exploiting operating systems ahead of when devices (e.g., laptops, tablets, phones, etc.) include such non-volatile memory platforms because a redesigned OS will still run efficiently on existing hardware platforms that include volatile memory devices.

Thus, from an OS perspective (i.e., an OS redesigned to utilize non-volatile memory rather than volatile memory), the OS will address a request (e.g., data retrieval or storage) to a non-volatile memory location. Given that an embodiment has simulated that non-volatile memory location using volatile memory, the request is actually directed to the volatile memory location. The OS is provided with the request response, e.g., data retrieved from the volatile memory. Thus, the inclusion of or use of volatile memory is blind from the OS perspective. As described herein, as a precaution, because volatile memory is being used as non-volatile memory, and the OS likely will not be apprised of this, an embodiment may copy data stored in the simulated non-volatile memory (which is actually volatile memory) back to actual non-volatile storage (e.g., HDD, flash, etc.). This may be accomplished periodically or frequently or according to a schedule (e.g., at times when the volatile memory is known to lose power, e.g., at system shut down).

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, using a processor, a volatile memory device of an information handling device; and
designating, using a processor, at least a portion of the volatile memory device as simulated non-volatile memory.

2. The method of claim 1, further comprising detecting, using a processor, a trigger event.

3. The method of claim 2, wherein the detecting is performed according to a predetermined timing policy.

4. The method of claim 2, wherein the trigger event is selected from the group events consisting of a predetermined time being exceeded, a predetermined amount of simulated non-volatile memory being utilized, and an event removing power from the simulated non-volatile memory.

5. The method of claim 2, further comprising, responsive to detecting the trigger event, copying at least a portion of information stored in the simulated non-volatile memory to a backing store.

6. The method of claim 5, wherein the backing store is a storage device selected from the group of storage devices consisting of a hard disk drive, a flash memory, and non-volatile random access memory.

7. The method of claim 2, wherein the detecting is performed during operation of the information handing device under control of an operating system.

8. The method of claim 1, wherein the designating is performed during a boot up process of an operating system of the information handling device.

9. The method of claim 1, wherein the simulated non-volatile memory is a portion of main memory of the information handling device.

10. The method of claim 1, wherein the simulated non-volatile memory is cleared according to a predetermined timing policy.

11. An information handling device, comprising:
a volatile memory device;
a processor; and
a memory device storing instructions executable by the processor to:
detect the volatile memory device of an information handling device; and
designate at least a portion of the volatile memory device as simulated non-volatile memory.

12. The information handling device of claim 11, wherein the instructions are further executable by the processor to detect a trigger event.

13. The information handling device of claim 12, wherein detecting a trigger event is performed according to a predetermined timing policy.

14. The information handling device of claim 12, wherein the trigger event is selected from the group events consisting of a predetermined time being exceeded, a predetermined amount of simulated non-volatile memory being utilized, and an event removing power from the simulated non-volatile memory.

15. The information handling device of claim 12, wherein the instructions are further executable by the processor to, responsive to detecting the trigger event, copy at least a portion of information stored in the simulated non-volatile memory to a backing store.

16. The information handling device of claim 15, wherein the backing store is a storage device selected from the group of storage devices consisting of a hard disk drive, a flash memory, and non-volatile random access memory.

17. The information handling device of claim 12, wherein the trigger event is detected during operation of the information handing device under control of an operating system.

18. The information handling device of claim 11, wherein designating at least a portion of the volatile memory device as simulated non-volatile memory is performed during a boot up process of an operating system of the information handling device.

19. The information handling device of claim 11, wherein the simulated non-volatile memory is a portion of main memory of the information handling device.

20. A program product, comprising:
a storage medium comprising computer readable program code, the computer readable program code comprising:
computer readable program code configured to detect, using a processor, a volatile memory device of an information handling device; and
computer readable program code configured to designate, using a processor, at least a portion of the volatile memory device as simulated non-volatile memory.
